(19) United States
(12) Patent Application Publication
(10) Pub. No.: US 2006/0192825 A1
(43) Pub. Date: Aug. 31, 2006

(54) Photo inkjet ink sets with high and low density yellow pigments

(75) Inventors: Paul Sacoto, Lexington, KY (US); Ajay Kanubhai Suthar, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/065,755

(22) Filed: Feb. 25, 2005

(51) Int. Cl. G01D 11/00

(52) U.S. Cl. 347/100

(57) ABSTRACT

An ink set of at least four colors includes a high density cyan (C), a low density cyan (c), or a high density magenta (M), or a low density magenta (m), or both the cyans and magentas, and a high density yellow comprising Pigment Yellow 74, and a low density yellow comprising Pigment Yellow 155. The low density inks may be in a single cartridge having three, separate ink compartments, as is known for three color inks. Similarly, the high density inks may be in separate compartments of another cartridge. A third cartridge may contain other inks such a high density or low density black. In printing by the foregoing ink set for photographic quality the low density yellow ink may be favored, which provides maximum resistance to fade, while the high density ink is used as desired for more vibrant images.

### TECHNICAL FIELD

This invention relates to inkjet inks for printing full color photographs or similar pictures having excellent resistance to fade. Such inks can be printed by thermal, drop- on-demand inkjet printing.

### BACKGROUND OF THE INVENTION

It has long been known that inks of various optical densities provide a set of inks useful for printing a range of colors of photographic quality. The following U.S. patents are representative of this: 4,560,997 to Sato et al., 4,672,432 to Sakurada, 4,855,753 to Ichikawa et al., and 5,742,306 to Gompertz et al. Such ink set in the prior art often have three high density inks of cyan (C), magenta (M), and yellow (Y) while having a low density cyan (c) and a low density magenta (m), but not having a low density yellow (y). Instead a sixth color is a high density or low density black. As human visual perception is less acute with respect to yellow, the lack of a low density yellow can be compensated for in the printing.

However, the yellow used for the high density must be selected from existing colorants, and those which are high density do not have the very long term resistance to fade which is desirable for photographic quality printing. Accordingly, a need exists to achieve both long-term fade resistance and good yellow color in photographic inkjet printing.

### DISCLOSURE OF THE INVENTION

An ink set of at least four colors includes a high density cyan (C), a low density cyan (c), or a high density magenta (M), or a low density magenta (m), or both the cyans and magentas, and a high density yellow comprising Pigment Yellow 74, and a low density yellow comprising Pigment Yellow 155. The low density inks may be in a single cartridge having three, separate ink compartments, as is known for three color inks. Similarly, the high density inks may be in separate compartments of another cartridge. A third cartridge may contain other inks such a high density or low density black. Such cartridges may be installed in a printer or removed for replacement by another of such cartridge manually or otherwise.

In printing by the foregoing ink set for photographic quality the low density yellow ink may be favored, which provides maximum resistance to fade, while the high density ink is used as desired for more vibrant images. Where the high density yellow is used, the low density yellow optionally can be printed over it or with it in selected amounts to minimize fade.

### DETAILED DESCRIPTION

Preferred vibrant colors are Pigment Blue 15:4 (C), Pigment Red 122 (M), and Pigment Yellow 74 (Y). However, Pigment Yellow 74 fades considerably faster than both the foregoing C and M. Pigment Yellow 155 has excellent fade resistance, but less color vibrancy than Pigment Yellow 74.

These two yellow pigments are compatible and do not interact., and, accordingly, they can be mixed. This invention, however, is to providing them as separate inks so that their individual characteristics can be selectively utilized.

The structure of Pigment Yellow 155 is that shown and discussed in detail in U.S. Pat. No. 5,616,778 to Goldmann et al. Since it is primarily a highly resonate linkage of nitrogen and phenyl groups, alkyl substituted Pigment Yellow 155 would be largely neutral to its color and fade resistance. Accordingly, this invention contemplates the use of either or both Pigment Yellow 155 or an alkyl substituted Pigment Yellow 155. The structure of Pigment Yellow 74 is shown at column 8 of U.S. Pat. No. 5,944,427, to Kappele et al., and assigned to the assignee of this invention. Similarly, since it is a highly resonate linkage of nitrogen and phenyl groups, alkyl substituted Pigment Yellow 74 would be largely neutral to its color. Accordingly, this invention contemplates the use of either or both Pigment Yellow 74 or an alkyl substituted Pigment Yellow 74.

This invention may be implemented in traditional six color systems which consist of two cartridges: a dark or vibrant color-containing cartridge having C, M, and Y inks, and a light color-containing cartridge having dilute c, m, k (the lower case k being an abbreviation for dilute black). Generally, the cmk cartridge is interchangeable with a cartridge having full density (K) black (which may be a process black). Thus, a typical six color system comprises a CMY-K two cartridge arrangement for plain or high yield printing, and a CMY-cmk for high, photographic quality printing.

The usual intent of a six color system is the minimization of grain, thus providing high printing quality intended naturally but not limited to photographic media. Grain results from dense inks printed in dots spaced to seek a light shade. A six color operation maximizes the use of the dilute cyan and magenta for diffuse areas of low to moderate c and m coverage, such as skin tone and skies. The dilute dots are less visible to the eye when scattered and grain is improved. Grain is also improved by smaller dot sizes.

This invention changes the k in the foregoing standard six color system to y in the form of an ink comprising Pigment Yellow 155. In an embodiment the CMY inks are 4 to 6% by weight of the ink in an aqueous media which may be a standard inkjet ink of colorant of, respectively, Pigment Blue 15:4, Pigment Red 122, and Pigment Yellow 74. For ordinary or high yield printing, the second cartridge is K, a high density ink, which may be a standard inkjet ink of carbon black.

For photographic quality printing an embodiment cmy cartridge has cm inks which are the same as those of the CMY cartridge except that the pigments are in about of 1-3.5% by weight of the ink. The yellow ink differs from the foregoing Y ink in that the colorant is Pigment Yellow 155 in amount of 1-3.5% by weight of the ink. In further variants, when only a three chamber system is available for dilute inks, y can substitute for any of c, m, or k as needed.

During printing in plain media, the printer utilizes only the vibrant colors and the full black. During printing of photographic quality images, the printer is driven to use the y, the fade-resistant yellow, to enhance fade resistance. This may be by avoiding use of the Y ink where some other technique will give the same image effect. An preferred alternative is to selectively combine the Y and y inks on the printed surface. The y ink may be placed on top to serve to protect the Y ink from fade.

Of course, ink sets of more than six inks are consistent with this invention and various printers and printing techniques may be employed.

What is claimed is:

1. An ink set comprising a high optical density magenta ink and a low optical: density magenta ink or a high optical density cyan ink and a low optical density cyan ink and a high optical density yellow ink comprising Pigment Yellow 74 or an alkyl substituted Pigment Yellow 74 and a low optical density yellow ink comprising Pigment Yellow 155 or an alkyl substituted Pigment Yellow 155, wherein said ink set can print color images by inkjet printing.

2. The ink set of claim 1 comprising a high optical density magenta ink, a low optical density magenta ink, a high optical density cyan ink, and a low optical density cyan ink.

3. The ink set of claim 1 in which said high optical density yellow ink comprises Pigment Yellow 74.

4. The ink set of claim 2 in which said high optical density yellow ink comprises Pigment Yellow 74.

5. The ink set of claim 3 in which said low optical density yellow ink comprises Pigment Yellow 155.

6. The ink set of claim 4 in which said low optical density yellow ink comprises Pigment Yellow 155.

7. The ink set of claim 1 in which said low optical density yellow ink comprises Pigment Yellow 155.

8. The ink set of claim 2 in which said low optical density yellow ink comprises Pigment Yellow 155.
